(19) United States
(12) Patent Application Publication
(10) Pub. No.: US 2025/0343491 A1
(43) Pub. Date: Nov. 6, 2025

(54) OUTPUT VOLTAGE-BASED SELF-ADAPTIVE ROTOR PRE-POSITIONING CONTROL METHOD FOR PERMANENT MAGNET SYNCHRONOUS MOTOR

(71) Applicant: ZHONGSHAN BROAD-OCEAN MOTOR CO., LTD., Zhongshan (CN)

(72) Inventors: Fei YANG, Zhongshan (CN); Hairong SUN, Zhongshan (CN); Zhejiang LIU, Zhongshan (CN)

(21) Appl. No.: 19/270,441

(22) Filed: Jul. 15, 2025

Related U.S. Application Data
(63) Continuation of application No. PCT/CN2023/113417, filed on Aug. 16, 2023.

(30) Foreign Application Priority Data
Mar. 3, 2023 (CN) 202310193016.8

(51) Int. Cl. H02P 21/05; F04D 25/06

(52) U.S. Cl. CPC H02P 21/05; F04D 25/06; H02P 2207/05

(57) ABSTRACT

Disclosed in the present invention is an output voltage-based self-adaptive rotor pre-positioning control method for a permanent magnet synchronous motor, comprising: step 1: setting a target rotor position θ and output voltages, initializing U_{d} and U_{q} to zero, then detecting the amplitude of a feedback current vector iₛ in real time while gradually increasing the output value of U_{d}, the output value being increased by Δu each time, comparing the amplitude of the feedback current vector is with a set current value iₒ, when U_{d} is increased for the M^{th} time, U_{d}=MΔu, and when the amplitude of the current vector iₛ is greater than or equal to the set current value iₒ, entering step 2; and step 2: using the set target rotor position θ, U_{d}=MΔu and U_{q}=0 as target parameters to be outputted to control the motor, and detecting a feedback current in real time; determining whether the current is stable, and if yes, determining that a pre-positioning process has been completed, and the motor has been stably positioned at the target rotor position; and if the current is unstable, continuing to wait for the current to stabilize. In the present invention, output voltages are used for pre-positioning, and phase currents are sampled to achieve a current closed loop, thereby finally achieving self-adaptive, rapid and shake-free pre-positioning.

### RELATED APPLICATIONS

This application is a continuation of International Application No. PCT/CN2023/113417, filed Aug. 16, 2023 and claims priority to Chinese Patent Application Ser. No. 202310193016.8, filed Mar. 3, 2023, the disclosures of which are incorporated by reference in their entirety.

### FIELD OF THE DISCLOSURE

The present invention relates to an output voltage-based self-adaptive rotor pre-positioning control method for a permanent magnet synchronous motor.

### BACKGROUND

FIG. 1 is a block diagram of control of a permanent magnet synchronous motor using vector control. Before the motor is started, a rotor needs to be pre-positioned to make the rotor stop at a designated position, thereby facilitating successful startup.

In a conventional rotor pre-positioning method, a conventional fixed duration output current-based pre-positioning method is used. Referring to FIG. 1 and FIG. 2, in the working principle of the method, currents i_{d}* and i_{q}* and a target rotor position are specified by using chip software inside a microcontroller unit (MCU). Feedback currents obtained by sampling the three-phase currents of the motor are i_{d} and i_{q}, and are processed through a current loop PI to obtain output voltages U_{d} and U_{q}. Finally, these voltages are modulated by an SVPWM module for output to control power switching transistors of an inverter circuit. Under high-inertia loads, for example, large impeller fans, when an output current controls a motor rotor to be positioned at a target position, the motor rotor oscillates around the target position due to high load inertia. This results in fluctuations in feedback currents i_{d} and i_{q} calculated from three-phase currents. Subsequently, after processing by PI regulators, U_{d} and U_{q} follow these fluctuations, ultimately resulting in fluctuations in voltages output to stator windings of the motor. This exacerbates the oscillation of the motor rotor, causing hunting and failure to achieve rapid pre-positioning.

Additionally, fluctuations in the bus voltage of the inverter circuit due to grid voltage variations, combined with differences in motor parameters and voltage drops across power devices, result in inconsistent current outputs for identical voltages U_{d} and U_{q}. This leads to different pre-positioning torque, degraded consistency, and increased control complexity.

Furthermore, pre-positioning duration is typically fixed in a conventional pre-positioning solution. For low-inertia loads or no-load conditions, this results in unnecessarily prolonged pre-positioning duration, compromising startup rapidity. For high-inertia loads, the pre-positioning duration may be insufficient, and the motor fails to stabilize its position, affecting the startup success rate, thus demonstrating poor self-adaptability.

### SUMMARY

An objective of the present invention is to provide an output voltage-based self-adaptive rotor pre-positioning control method for a permanent magnet synchronous motor, to solve the technical problem in the related art that a permanent magnet synchronous motor with vector control uses a fixed duration output current-based pre-positioning method, and for high-inertia loads, hunting and failure to achieve rapid pre-positioning may be caused, and self-adaptability is poor for fixed pre-positioning duration.

A further objective of the present invention is to provide an output voltage-based self-adaptive rotor pre-positioning control method for a permanent magnet synchronous motor, to solve the problems in the related art that a permanent magnet synchronous motor with vector control uses a fixed duration output current-based pre-positioning method, fluctuations in the bus voltage of the inverter circuit due to grid voltage variations, combined with differences in motor parameters and voltage drops across power devices, result in different pre-positioning torque, degraded consistency, and increased control complexity.

The present invention is implemented by using the following technical solution:

An output voltage-based self-adaptive rotor pre-positioning control method for a permanent magnet synchronous motor is provided, where the permanent magnet synchronous motor includes a motor body and a motor controller, the motor body includes a stator assembly and a permanent magnet rotor assembly, the motor controller includes an MCU and an inverter circuit, the inverter circuit includes a plurality of bridge arms, each of the bridge arms includes an upper bridge arm power switching transistor and a lower bridge arm power switching transistor, and the rotor pre-positioning control method is as follows:
step 1: setting a target rotor position θ and output voltages, where control of the output voltages meets the following conditions: the output voltages are transformed into a d-axis output voltage U_{d} and a q-axis output voltage U_{q}, U_{d} and U_{q} are initialized to zero, an amplitude of a feedback current vector iₛ is then detected in real time while gradually increasing an output value of U_{d}, the output value being increased by Δu each time, the amplitude of the feedback current vector iₛ is compared with a set current value iₒ, when U_{d} is increased for an M^{th} time, U_{d}=MΔu is set, and when the amplitude of the current vector iₛ is greater than or equal to the set current value iₒ, step 2 is performed; and
step 2: using the set target rotor position θ, U_{d} having a magnitude of MΔu, and U_{q} having a magnitude of zero as target parameters to be outputted to control the motor, and detecting a feedback current in real time; determining whether the current is stable, and if yes, determining that a pre-positioning process is completed, and the motor is stably positioned at the target rotor position; and if the current is unstable, continuing to wait for the current to stabilize, where
U_{d} is a d-axis output voltage in a dq rotor rotating coordinate system, U_{q} is a q-axis output voltage in the dq rotor rotating coordinate system, the amplitude of the current vector iₛ is a current amplitude of a resultant vector of a d-axis feedback current i_{d} and a q-axis feedback current i_{q}, and M is an integer.

The output voltages are directly the output voltage U_{d} and the output voltage U_{q}, or the output voltages are voltages U_{α} and U_{β}, or the output voltages are three-phase voltages U_{A}, U_{B}, and U_{C}, U_{α} is an α-axis voltage, U_{β} is a β-axis voltage, U_{A} is a phase-A winding voltage, U_{B} is a phase-B winding voltage, and U_{C} is a phase-C winding voltage.

The determining whether the current is stable is determining whether the d-axis feedback current i_{d} is stable, or is determining whether the q-axis feedback current i_{q} is stable, or is determining whether a current i_{α} is stable, or is determining whether a current i_{β} is stable, or is determining whether a current iₐ is stable, or is determining whether a current i_{b} is stable, or is determining whether a current i_{c} is stable, where i_{α} is an α-axis current, i_{β} is a β-axis current, iₐ is a phase-A winding current, i_{b} is a phase-B winding current, and i_{c} is a phase-C winding current.

The output voltages in step 1 are the voltage U_{d} and the voltage U_{q}, and step 1 may be divided into the following steps:
step (1): setting the target rotor position θ in the MCU, and initializing U_{d} and U_{q} to zero, where M=1;
step (2): setting U_{d}=M×Δu in the MCU, performing a coordinate transformation by using current U_{d}, U_{q}, and θ, and then outputting results to an SVPWM module, where the SVPWM module generates a modulated pulse signal corresponding to a target output voltage to control switching of the power switching transistors of the inverter circuit;
step (3): sampling three-phase currents and sending the sampled three-phase currents to the MCU to obtain phase currents iₐ, i_{b}, and i_{c};
step (4): performing a Clarke transformation on the sampled three-phase currents iₐ, i_{b}, and i_{c} to obtain i_{α} and i_{β}:

$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$

and
then performing a Park transformation on i_{α} and i_{β}, and the target rotor position in step 1 to obtain i_{d} and i_{q}:

$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$

step (5): calculating the amplitude of the current vector is:

$${i}_{s} = \sqrt{{i}_{d}^{2} + {i}_{q}^{2}} ;$$

step (6): determining whether the amplitude of the current vector iₛ is greater than or equal to the set current value iₒ, and if yes, proceeding to step 2; or if not, setting M=M+1, and returning to step (2).

Step 2 may be divided into the following steps:
step (7): specifying the set target rotor position θ, U_{d} having a magnitude of MΔu, and U_{q} having a magnitude of zero as the target parameters to be outputted to the SVPWM module;
step (8): sampling three-phase currents and sending the sampled three-phase currents to the MCU to obtain phase currents iₐ, i_{b}, and i_{c};
step (9): performing a Clarke transformation on the sampled three-phase currents iₐ, i_{b}, and i_{c} to obtain i_{α} and i_{β}:

$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$

and
then performing a Park transformation on i_{α} and i_{β}, and the target rotor position in step 1 to obtain i_{d} and i_{q}:

$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$

and
step (10): calculating a coefficient of variation γ of the d-axis feedback current id using statistical methods to determine whether the current is stable, and if the coefficient of variation γ is less than a set coefficient of variation value γₒ, determining that the pre-positioning process is completed, and the motor is stably positioned at the target rotor position, or otherwise, returning to step (8) to continue to wait for the current to stabilize.

The coefficient of variation γ of the d-axis feedback current i_{d} is calculated using the following method:
a: selecting a feedback current i_{d} calculated through N consecutive times of sampling, where a feedback current i_{d} of a j^{th} time is denoted as i_{d_j};
b: calculating an average current of the feedback currents i_{d} of the N times:

$${i}_{d\_ave} = \frac{{\sum }_{j = 1}^{N} {i}_{d\_ j}}{N} ;$$

c: calculating a standard deviation of the feedback currents i_{d} of the N times:

$$σ = \sqrt{\frac{{\sum }_{j = 1}^{N} {( {i}_{d\_j} - {i}_{d\_ave} )}^{2}}{N}} ;$$

and
d: calculating a coefficient of variation of the feedback currents i_{d} of the N times:

$$γ = \frac{σ}{{i}_{d\_ave}} .$$

A value range of the set coefficient of variation value γₒ is 0.1 to 0.2.

A value range of the set current value iₒ is 40% to 60% of a rated current of the motor.

Compared with the prior art, the present invention has the following effects:

(1) Compared with a conventional pre-positioning method using command currents i_{d} and i_{q}, in the present invention, pre-positioning using voltage outputs U_{d} and U_{q} can effectively reduce hunting duration in a pre-positioning process, and the effect is particularly pronounced for high-inertia load scenarios. When output voltages are used for pre-positioning, voltages are directly output to stator windings of a motor, and output voltages U_{d} and U_{q} remain constant direct-current values. Compared with pre-positioning using current outputs, the oscillation and hunting of a motor rotor are reduced, and the hunting duration in the pre-positioning process is shortened.

(2) In the present invention, U_{d} and U_{q} are initialized to zero, an amplitude of a feedback current vector iₛ is then detected in real time while gradually increasing an output value of U_{d}, the output value being increased by Δu each time, the amplitude of the feedback current vector iₛ is compared with a set current value iₒ, when U_{d} is increased for an N^{th} time, U_{d}=NΔu is set, and when the amplitude of the current vector iₛ is greater than or equal to the set current value iₒ, step 2 is performed. That is, with current closed-loop feedback incorporated, the present invention is self-adaptive to different inverter parameters and motor operating conditions, thereby achieving consistent pre-positioning current or torque.

(3) The present invention introduces the concept of coefficient of variation of a current to determine whether pre-positioning of a motor is stable, enabling self-adaptation to different load scenarios and achieving the fastest stable pre-positioning.

### BRIEF DESCRIPTION OF THE DRAWINGS

FIG. 1 is a block diagram of control of an existing permanent magnet synchronous motor with vector control;

FIG. 2 is a flowchart of software control of an existing permanent magnet synchronous motor with vector control;

FIG. 3 is a three-dimensional diagram of a permanent magnet synchronous motor according to the present invention;

FIG. 4 is an exploded view of a permanent magnet synchronous motor according to the present invention;

FIG. 5 is a structural cross-sectional view of a permanent magnet synchronous motor according to the present invention;

FIG. 6 is a block diagram of an implementation circuit of a motor of a fan according to the present invention;

FIG. 7 is a block diagram of the principle of vector control according to the present invention;

FIG. 8 is a schematic diagram of a current vector according to the present invention;

FIG. 9 is a flowchart of software control of step 1 according to the present invention;

FIG. 10 is a flowchart of software control of step 2 according to the present invention;

FIG. 11 is a schematic diagram of experimentally measured current fluctuations in a conventional fixed duration output current-based pre-positioning method for a permanent magnet synchronous motor; and

FIG. 12 is a schematic diagram of experimentally measured current changes of an output voltage-based self-adaptive rotor pre-positioning control method for a permanent magnet synchronous motor according to the present invention.

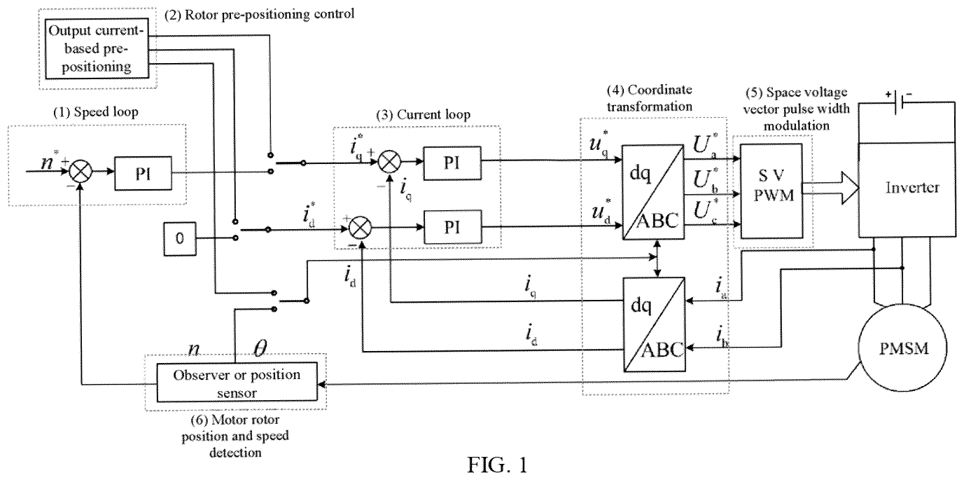

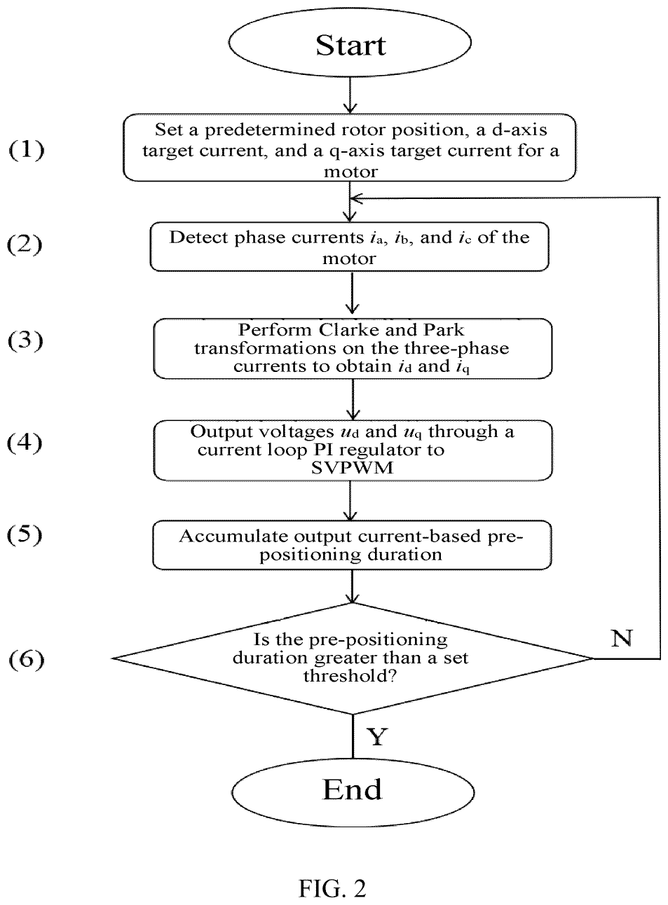

### DETAILED DESCRIPTION

The present invention is further described below in detail by using specific embodiments with reference to the accompanying drawings.

### Embodiment 1

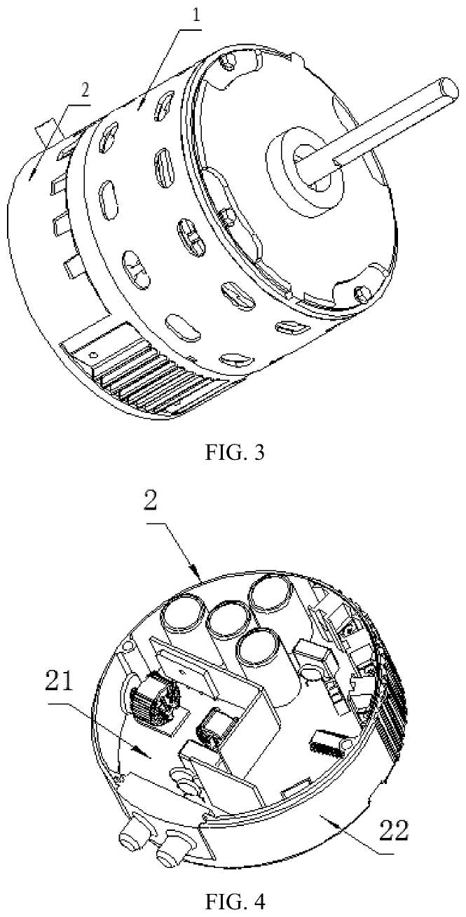

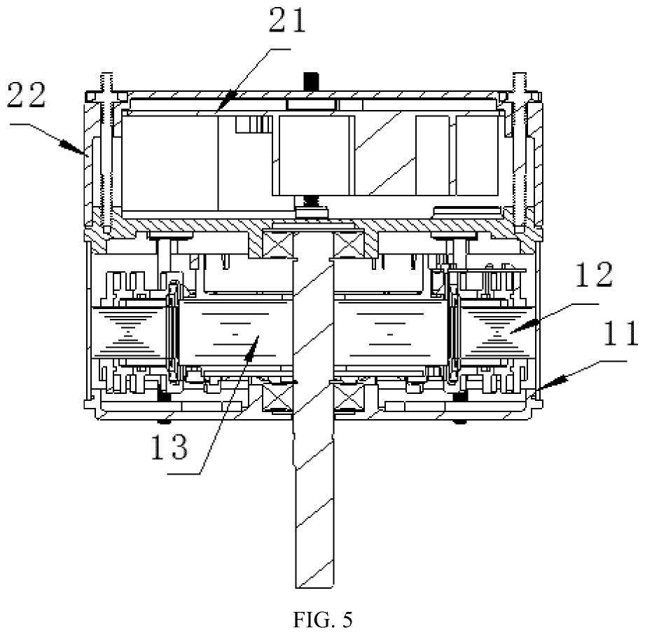

Referring to FIG. 3, FIG. 4, and FIG. 5, a novel fan of the present invention includes a permanent magnet synchronous motor and an impeller 3. The permanent magnet synchronous motor includes a motor body 1 and a motor controller 2. The motor body 1 includes a stator assembly 12, a rotor assembly 13, and a housing assembly 11. The stator assembly 12 includes a stator core and coil windings wound around the stator core. The stator assembly 12 is mounted on the housing assembly 11. The rotor assembly 13 is sleeved on an inner side of the stator assembly 12. The motor controller 2 includes a control box 22 and a control circuit board 21 mounted inside the control box 22. Electronic components are mounted on the control circuit board 21. As shown in FIG. 4, the circuit structure of the control circuit board 21 includes a rectifier circuit, a direct-current bus, an inverter circuit, an MCU, a phase current detect circuit for each phase winding, and a rotor position detect circuit.

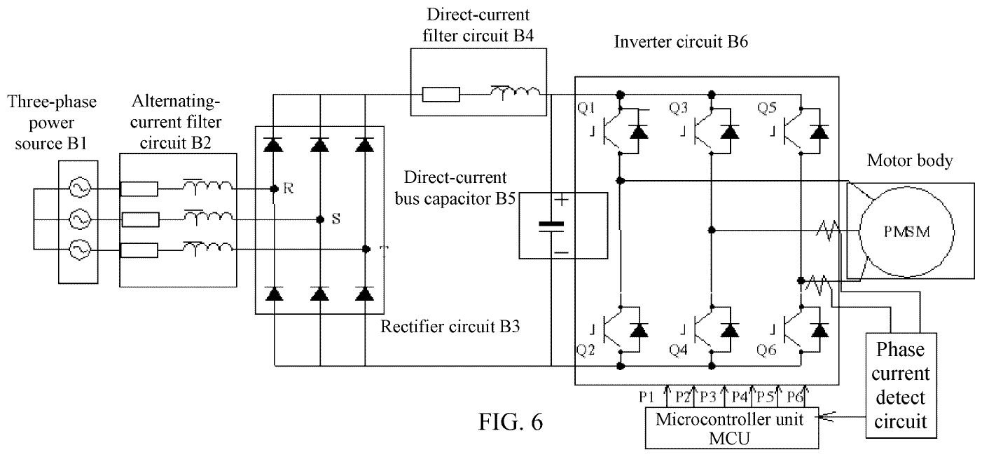

As shown in FIG. 6, the motor controller includes an alternating-current filter circuit B2, a rectifier circuit B3, a direct-current filter circuit B4, a direct-current bus capacitor B5, an inverter circuit B6, an MCU, and a phase current detect circuit. A three-phase power source B1 (an alternating current power source) sequentially passes through the alternating-current filter circuit B2, the rectifier circuit B3, the direct-current filter circuit B4 to charge the direct-current bus capacitor B5. The direct-current bus capacitor B5 supplies high-voltage direct-current power to the inverter circuit B6. The phase current detect circuits detects a phase current flowing through the coil windings and sends the phase current to the MCU. The MCU controls the inverter circuit to operate. The inverter circuit controls the energization and de-energization of each phase winding of the stator assembly. The permanent magnet synchronous motor uses field-oriented control FOC. The motor body 1 is a 3-phase motor. The stator assembly of the motor body 1 includes 3-phase coil windings. The inverter circuit B6 includes three bridge arms. Upper-bridge arm electronic switching transistors are Q1, Q3, and Q5, and lower-bridge arm electronic switching transistors are Q2, Q4, and Q6. PMSM is the abbreviation for Permanent Magnet Synchronous Motor. The permanent magnet synchronous motor of the present invention uses a three-phase permanent magnet synchronous motor as an example to describe the operational principle of the present invention. The stator assembly 12 includes a stator core and three-phase windings A, B, and C wound around the stator core.

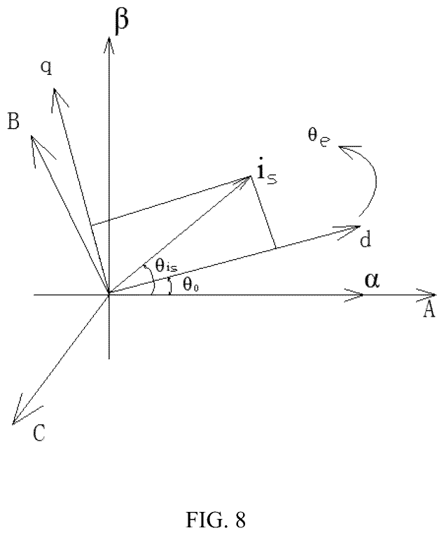

FIG. 8 is a schematic diagram of a current vector according to the present invention. Let pre-positioning current vector be iₛ with an angle be θᵢₛ, and an actual motor rotor position be θₑ. However, in an output voltage-based pre-positioning method, the motor rotor position θₑ is locked to a target rotor position θ. Two coordinate systems exist in FIG. 8, one being a dq rotor rotating coordinate system, and the other being an αβ stationary coordinate system. A, B, and C represent three-phase windings.

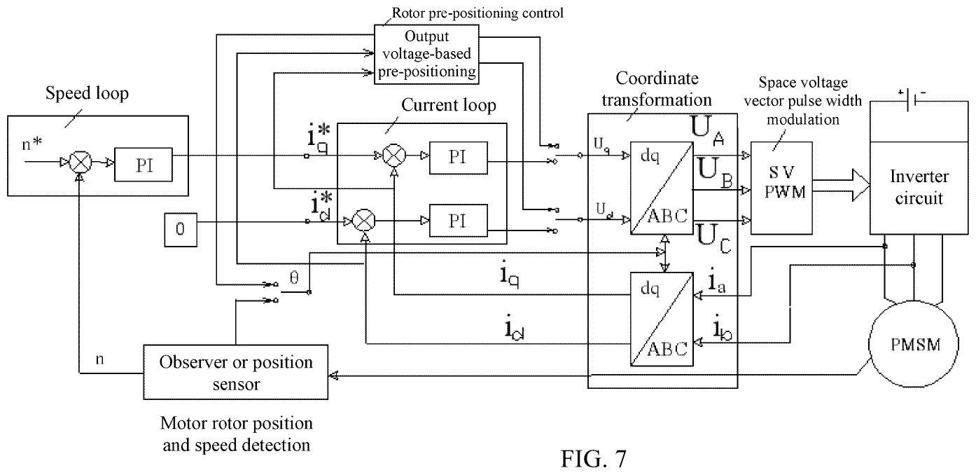

As shown in FIG. 7, an output voltage-based self-adaptive rotor pre-positioning control method for a permanent magnet synchronous motor of the present invention is provided, where the permanent magnet synchronous motor includes a motor body and a motor controller, the motor body includes a stator assembly and a permanent magnet rotor assembly, the motor controller includes an MCU and an inverter circuit, the inverter circuit includes a plurality of bridge arms, each of the bridge arms includes an upper bridge arm power switching transistor and a lower bridge arm power switching transistor, and the rotor pre-positioning control method is as follows:
step 1: setting a target rotor position θ and output voltages, where control of the output voltages meets the following conditions: the output voltages are transformed into a d-axis output voltage U_{d} and a q-axis output voltage U_{q}, U_{d} and U_{q} are initialized to zero, an amplitude of a feedback current vector iₛ is then detected in real time while gradually increasing an output value of U_{d}, the output value being increased by Δu each time, the amplitude of the feedback current vector iₛ is compared with a set current value iₒ, when U_{d} is increased for an M^{th} time, U_{d}=MΔu is set, and when the amplitude of the current vector iₛ is greater than or equal to the set current value iₒ, step 2 is performed; and
step 2: using the set target rotor position θ, U_{d} having a magnitude of MΔu, and U_{q} having a magnitude of zero as target parameters to be outputted to control the motor, and detecting a feedback current in real time; determining whether the current is stable, and if yes, determining that a pre-positioning process is completed, and the motor is stably positioned at the target rotor position; and if the current is unstable, continuing to wait for the current to stabilize, where
U_{d} is a d-axis output voltage in a dq rotor rotating coordinate system, U_{q} is a q-axis output voltage in the dq rotor rotating coordinate system, the amplitude of the current vector iₛ is a current amplitude of a resultant vector of a d-axis feedback current i_{d} and a q-axis feedback current i_{q}, and M is an integer.

The output voltages are directly the output voltage U_{d} and the output voltage U_{q}, or the output voltages are voltages U_{α} and U_{β}, or the output voltages are three-phase voltages U_{A}, U_{B}, and U_{C}, U_{α} is an a-axis voltage, U_{β} is a β-axis voltage, U_{A} is a phase-A winding voltage, U_{B} is a phase-B winding voltage, and U_{C} is a phase-C winding voltage.

The determining whether the current is stable is determining whether the d-axis feedback current i_{d} is stable, or is determining whether the q-axis feedback current i_{q} is stable, or is determining whether a current i_{α} is stable, or is determining whether a current i_{q} is stable, or is determining whether a current iₐ is stable, or is determining whether a current i_{b} is stable, or is determining whether a current i_{c} is stable, where i_{α} is an α-axis current, i_{β} is a β-axis current, i_{α} is a phase-A winding current, i_{b} is a phase-B winding current, and i_{c} is a phase-C winding current.

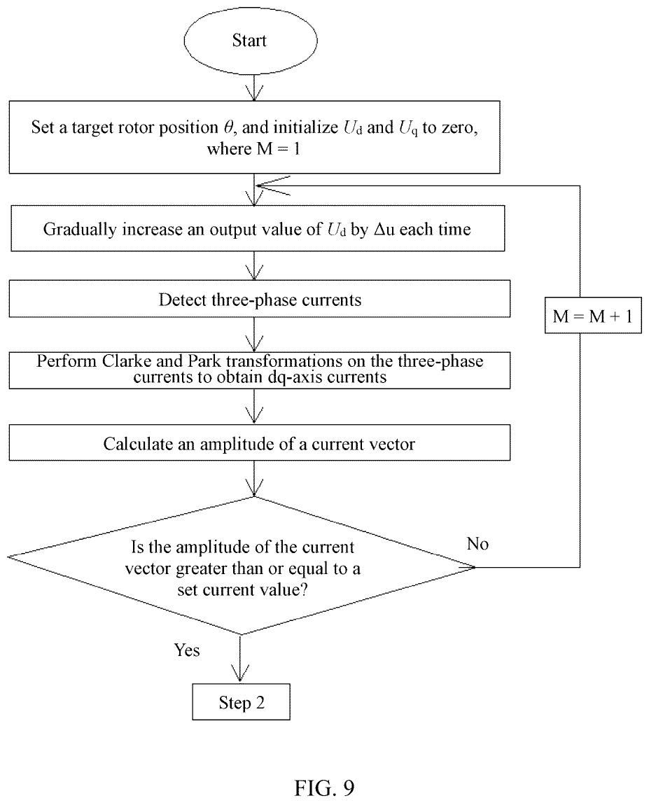

As shown in FIG. 9, the output voltages in step 1 are the voltage U_{d} and the voltage U_{q}, and step 1 may be divided into the following steps:
step (1): setting the target rotor position θ in the MCU, and initializing U_{d} and U_{q} to zero, where M=1;
step (2): setting U_{d}=M×Δu in the MCU, performing a coordinate transformation by using current U_{d}, U_{q}, and θ, and then outputting results to an SVPWM module, where the SVPWM module generates a modulated pulse signal corresponding to a target output voltage to control switching of the power switching transistors of the inverter circuit;
step (3): sampling three-phase currents and sending the sampled three-phase currents to the MCU to obtain phase currents iₐ, i_{b}, and i_{c};
step (4): performing a Clarke transformation on the sampled three-phase currents iₐ, i_{b}, and i_{c} to obtain i_{α} and i_{β}:

$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$

and
then performing a Park transformation on i_{α} and i_{β}, and the target rotor position in step 1 to obtain i_{d} and i_{q}:

$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$

step (5): calculating the amplitude of the current vector is:

$${i}_{s} = \sqrt{{i}_{d}^{2} + {i}_{q}^{2}} ;$$

and
step (6): determining whether the amplitude of the current vector iₛ is greater than or equal to the set current value iₒ, and if yes, proceeding to step 2; or if not, setting M=M+1, and returning to step (2).

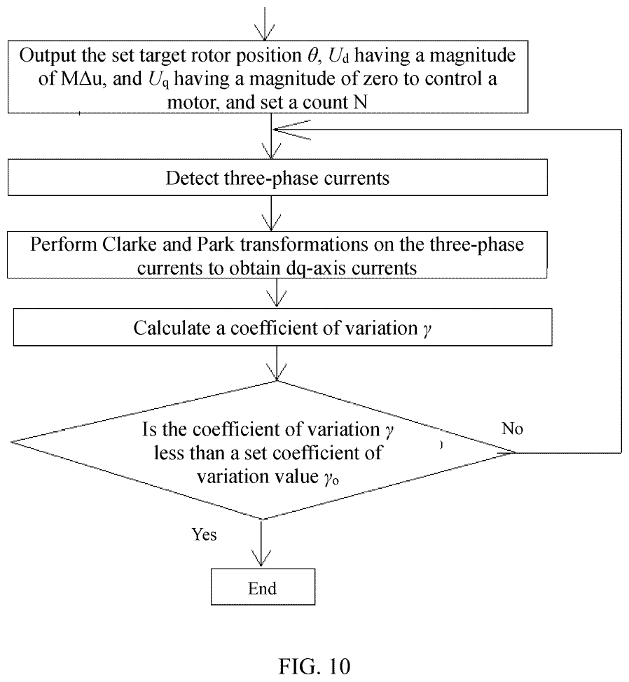

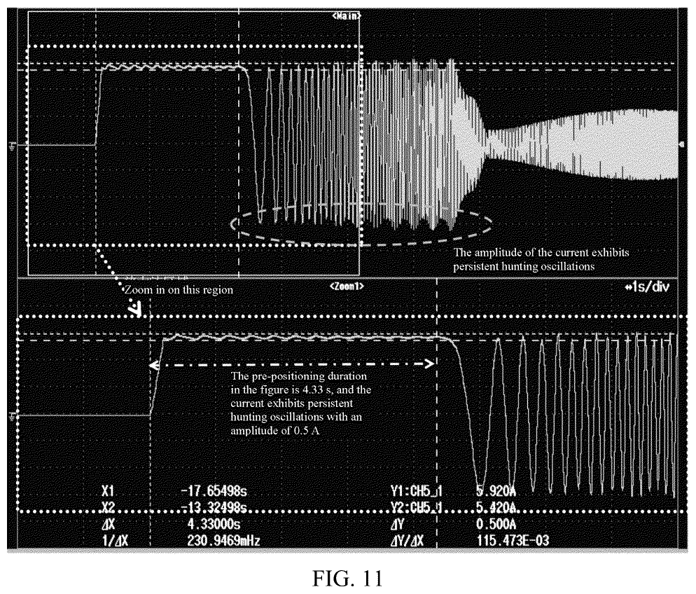

As shown in FIG. 10, step 2 may be divided into the following steps:
step (7): specifying the set target rotor position θ, U_{d} having a magnitude of MΔu, and U_{q} having a magnitude of zero as the target parameters to be outputted to the SVPWM module, and setting a statistical count N;
step (8): sampling three-phase currents and sending the sampled three-phase currents to the MCU to obtain phase currents iₐ, i_{b}, and i_{c};
step (9): performing a Clarke transformation on the sampled three-phase currents iₐ, i_{b}, and i_{c} to obtain i_{α} and i_{β}:

$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$

and
then performing a Park transformation on i_{α} and i_{β}, and the target rotor position in step 1 to obtain i_{d} and i_{q}:

$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$

and
step (10): calculating a coefficient of variation γ of the d-axis feedback current i_{d} using statistical methods to determine whether the current is stable, and if the coefficient of variation γ is less than a set coefficient of variation value γₒ, determining that the pre-positioning process is completed, and the motor is stably positioned at the target rotor position, or otherwise, returning to step (8) to continue to wait for the current to stabilize.

The coefficient of variation γ of the d-axis feedback current i_{d} is calculated using the following method:
a: selecting a feedback current i_{d} calculated through N consecutive times of sampling, where a feedback current i_{d} of a j^{th} time is denoted as i_{d_j};
b: calculating an average current of the feedback currents i_{d} of the N times:

$${i}_{d \_ ave} = \frac{{\sum }_{j = 1}^{N} {i}_{d \_ j}}{N} ;$$

c: calculating a standard deviation of the feedback currents i_{d} of the N times:

$$σ = \sqrt{\frac{{\sum }_{j = 1}^{N} {( {i}_{d \_ j} - {i}_{d \_ ave} )}^{2}}{N}} ;$$

and
d: calculating a coefficient of variation of the feedback currents i_{d} of the N times:

$$γ = \frac{σ}{{i}_{d \_ ave}} .$$

A value range of the set coefficient of variation value γₒ is 0.1 to 0.2.

A value range of the set current value iₒ is 40% to 60% of a rated current of the motor.

The present invention has the following three beneficial technical effects:

Effect 1: Compared with conventional pre-positioning using command currents i_{d} and i_{q}, in the present invention, pre-positioning using voltage outputs U_{d} and U_{q} can effectively reduce hunting duration in a pre-positioning process, and the effect is particularly pronounced for high-inertia load scenarios. In an output current-based pre-positioning manner, currents i_{d}* and i_{q}* are specified by using chip software inside an MCU. Feedback currents obtained by sampling the three-phase currents of the motor are i_{d} and i_{q}, and are processed through a current loop PI to obtain output voltages U_{d} and U_{q}. These voltages are then modulated by an SVPWM module for output to control power switching transistors of an inverter circuit. Under high-inertia loads, for example, large impeller fans, when an output current controls a motor rotor to be positioned at a target position, the motor rotor oscillates around the target position due to high load inertia. This results in fluctuations in feedback currents id and i_{q} calculated from three-phase currents. Subsequently, after processing by PI regulators, U_{d} and U_{q} follow these fluctuations, ultimately resulting in fluctuations in voltages output to stator windings of the motor. This exacerbates the oscillation of the motor rotor. When output voltages are used for pre-positioning in the present invention, voltages are directly output to stator windings of a motor, and output voltages U_{d} and U_{q} remain constant direct-current values. Compared with pre-positioning using current outputs, the oscillation and hunting of a motor rotor are reduced.

Effect 2: In a conventional pre-positioning method using command currents, fluctuations in the bus voltage of the inverter due to grid voltage variations, combined with differences in motor parameters and voltage drops across power switch devices, result in inconsistent current outputs for identical voltages U_{d} and U_{q}. This leads to different pre-positioning torque. With current closed-loop feedback incorporated, the output voltage-based pre-positioning method of the present invention is self-adaptive to different inverter parameters and motor operating conditions, thereby achieving consistent pre-positioning current or torque.

Effect 3: Pre-positioning duration is typically fixed in a conventional pre-positioning solution. For low-inertia loads or no-load conditions, this results in unnecessarily prolonged pre-positioning duration, compromising startup rapidity. For high-inertia loads, the pre-positioning duration may be insufficient, and the motor fails to stabilize its position, affecting the startup success rate. For the output voltage-based self-adaptive rotor pre-positioning control method of the present invention, the technical solution of the present invention introduces the concept of coefficient of variation of a current i_{d} to determine whether pre-positioning of a motor is stable, enabling self-adaptation to different load scenarios and achieving the fastest stable pre-positioning.

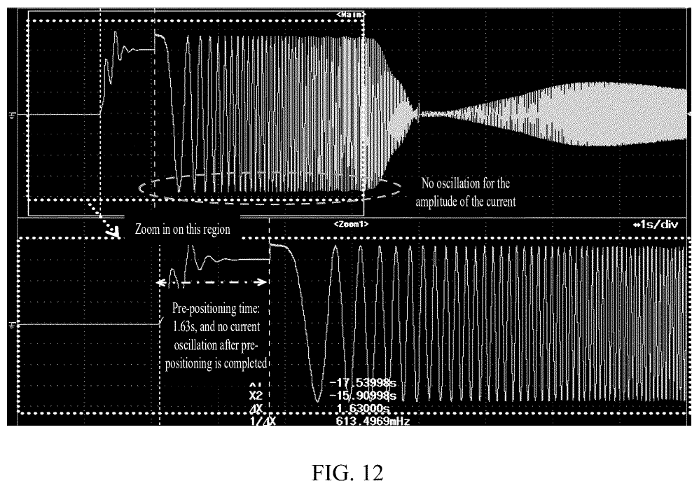

Experimental results demonstrate the feasibility of the technical solution in the present invention. The experimental platform is a 4.5 kW fan system with a load impeller having a diameter of 560 mm. The load impeller is driven by a permanent magnet synchronous motor and constitutes a high-inertia load. FIG. 11 shows phase current waveforms captured by an oscilloscope in a motor startup process in a conventional fixed duration output current-based pre-positioning solution for a permanent magnet synchronous motor. The pre-positioning duration in the figure is 4.33 seconds (fixed duration). The current exhibits persistent hunting oscillations with an amplitude of 0.5 A, and the current continues to fluctuate after pre-positioning, indicating that the rotor still oscillates. This further causes low-frequency oscillations in the current during subsequent open-loop operation, increasing the probability of loss of synchronization during the open-loop operation. FIG. 12 shows phase current waveforms captured by an oscilloscope in a motor startup process in an output voltage-based self-adaptive rotor pre-positioning control method for a permanent magnet synchronous motor of the present invention. The pre-positioning duration is 1.63 s, and the current stabilizes completely after pre-positioning is completed, indicating that the motor rotor reaches a complete standstill. No current oscillations occur during subsequent open-loop operation, thereby significantly improving the startup success rate.

Therefore, compared with the conventional solution, this solution achieves faster pre-positioning and eliminates rotor hunting.

### Technical Terms and Abbreviations Related to the Present Invention

SVPWM (Space Vector Pulse Width Modulation) is a method that superimposes a high-frequency carrier frequency onto an input signal and then outputs a high-frequency pulse signal to control power switching transistors in an inverter circuit. It is commonly referred to as an SVPWM module.

A d-axis iₛ the axis aligned with the N-pole of the motor.

A q-axis iₛ the axis that leads the N-pole of the motor by an electrical angle of 90 degrees.

PI is proportional-integral control.

Clarke transformation transforms parameters from a three-phase ABC coordinate system to parameters of an α axis and β axis coordinate system.

Park transformation transforms parameters from the α-axis and β-axis coordinate system to parameters of a d-axis and q-axis coordinate system.

U_{d} is a target voltage in a d-axis direction output by d-axis current loop PI regulation.

U_{q} is a target voltage in a q-axis direction output by q-axis current loop PI regulation.

U_{α} is an a-axis voltage obtained by applying an inverse Park (ipark) transformation to dq-axis voltages.

U_{β} is a β-axis voltage obtained by applying an inverse Park (ipark) transformation to dq-axis voltages.

U_{A} is a phase-A winding voltage obtained by applying an inverse Park (ipark) transformation to dq-axis voltages.

U_{B} is a phase-B winding voltage obtained by applying an inverse Park (ipark) transformation to dq-axis voltages.

U_{C} is a phase-C winding voltage obtained by applying an inverse Park (ipark) transformation to dq-axis voltages.

i_{d} is a d-axis current feedback value.

i_{q} is a q-axis current feedback value.

γ is a coefficient of variation.

i_{d_ave} is an average current of d-axis currents of N times.

σ is a variance.

The above embodiments are preferred embodiments of the present invention, but the embodiments of the present invention are not limited thereto. Any alterations, modifications, substitutions, combinations, or simplifications made without departing from the spirit, essence, and principles of the present invention shall be regarded as equivalent substitutions and fall within the scope of protection of the present invention.

1. An output voltage-based self-adaptive rotor pre-positioning control method for a permanent magnet synchronous motor, wherein the permanent magnet synchronous motor comprises a motor body and a motor controller, the motor body comprises a stator assembly and a permanent magnet rotor assembly, the motor controller comprises a microcontroller unit and an inverter circuit, the inverter circuit comprises a plurality of bridge arms, each of the bridge arms comprises an upper bridge arm power switching transistor and a lower bridge arm power switching transistor, and the rotor pre-positioning control method is as follows:
step 1: setting a target rotor position θ and output voltages, wherein control of the output voltages meets the following conditions: the output voltages are transformed into a d-axis output voltage U_{d} and a q-axis output voltage U_{q}, U_{d} and U_{q} are initialized to zero, an amplitude of a feedback current vector iₛ is then detected in real time while gradually increasing an output value of U_{d}, the output value being increased by Δu each time, the amplitude of the feedback current vector iₛ is compared with a set current value iₒ, when U_{d} is increased for an M^{th} time, U_{d}=MΔu is set, and when the amplitude of the current vector iₛ is greater than or equal to the set current value iₒ, step 2 is performed; and
step 2: using the set target rotor position θ, U_{d} having a magnitude of ΔAu, and U_{q} having a magnitude of zero as target parameters to be outputted to control the motor, and detecting a feedback current in real time; determining whether the current is stable, and if yes, determining that a pre-positioning process is completed, and the motor is stably positioned at the target rotor position; and if the current is unstable, continuing to wait for the current to stabilize, wherein
U_{d} is a d-axis output voltage in a dq rotor rotating coordinate system, U_{q} is a q-axis output voltage in the dq rotor rotating coordinate system, the amplitude of the current vector iₛ is a current amplitude of a resultant vector of a d-axis feedback current i_{d} and a q-axis feedback current i_{q}, and M is an integer.

2. The output voltage-based self-adaptive rotor pre-positioning control method for a permanent magnet synchronous motor according to claim 1, wherein the output voltages are directly the output voltage U_{d} and the output voltage U_{q}, or the output voltages are voltages U_{α} and U_{β}, or the output voltages are three-phase voltages U_{A}, U_{B}, and U_{C}, U_{α} is an α-axis voltage, U_{β} is a β-axis voltage, U_{A} is a phase-A winding voltage, U_{B} is a phase-B winding voltage, and U_{C} is a phase-C winding voltage.

3. The output voltage-based self-adaptive rotor pre-positioning control method for a permanent magnet synchronous motor according to claim 1, wherein the determining whether the current is stable is determining whether the d-axis feedback current i_{d} is stable, or is determining whether the q-axis feedback current i_{q} is stable, or is determining whether a current i_{α} is stable, or is determining whether a current i_{β} is stable, or is determining whether a current i_{α} is stable, or is determining whether a current i_{β} is stable, or is determining whether a current iₐ is stable, wherein i_{α} is an α-axis current, i_{β} is a β-axis current, i_{α} is a phase-A winding current, i_{b} is a phase-B winding current, and i_{c} is a phase-C winding current.

4. The output voltage-based self-adaptive rotor pre-positioning control method for a permanent magnet synchronous motor according to claim 3, wherein the output voltages in step 1 are the voltage U_{d} and the voltage U_{q}, and step 1 is divided into the following steps:
step (1): setting the target rotor position θ in the microcontroller unit, and initializing Va and U_{q} to zero, wherein M=1;
step (2): setting U_{d}=M×Δu in the microcontroller unit, performing a coordinate transformation by using current U_{d}, U_{q}, and θ, and then outputting results to an SVPWM module, wherein the SVPWM module generates a modulated pulse signal corresponding to a target output voltage to control switching of the power switching transistors of the inverter circuit;
step (3): sampling three-phase currents and sending the sampled three-phase currents to the microcontroller unit to obtain phase currents iₐ, i_{b}, and i_{c};
step (4): performing a Clarke transformation on the sampled three-phase currents: iₐ, i_{b}, and i_{c} to obtain i_{α} and i_{β}:
$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$
and
then performing a Park transformation on i_{α} and i_{β}, and the target rotor position in step 1 to obtain i_{d} and i_{q}:
$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$
step (5): calculating the amplitude of the current vector is:
$${i}_{s} = \sqrt{{i}_{d}^{2} + {i}_{q}^{2}} ;$$
and
step (6): determining whether the amplitude of the current vector iₛ is greater than or equal to the set current value iₒ, and if yes, proceeding to step 2; or if not, setting M=M+1, and returning to step (2).

5. The output voltage-based self-adaptive rotor pre-positioning control method for a permanent magnet synchronous motor according to claim 4, wherein step 2 is divided into the following steps:
step (7): specifying the set target rotor position θ, U_{d} having a magnitude of MΔu, and U_{q} having a magnitude of zero as the target parameters to be outputted to the SVPWM module;
step (8): sampling three-phase currents and sending the sampled three-phase currents to the microcontroller unit to obtain phase currents iₐ, i_{b}, and i_{c};
step (9): performing a Clarke transformation on the sampled three-phase currents iₐ, i_{b}, and i_{c} to obtain i_{α} and i_{β}:
$$\{ \begin{matrix}{i}_{α} = \frac{1}{3} ( 2 {i}_{a} - {i}_{b} - {i}_{c} ) \\ {i}_{β} = \frac{\sqrt{3}}{3} ( {i}_{b} - {i}_{c} )\end{matrix} ,$$
and
then performing a Park transformation on i_{α} and i_{β}, and the target rotor position in step 1 to obtain i_{d} and i_{q}:
$$\{ \begin{matrix}{i}_{d} = {i}_{α} cos ( θ ) + {i}_{β} sin ( θ ) \\ {i}_{q} = - {i}_{α} sin ( θ ) + {i}_{β} cos ( θ )\end{matrix} ;$$
and
step (10): calculating a coefficient of variation γ of the d-axis feedback current is using statistical methods to determine whether the current is stable, and if the coefficient of variation γ is less than a set coefficient of variation value γₒ, determining that the pre-positioning process is completed, and the motor is stably positioned at the target rotor position, or otherwise, returning to step (8) to continue to wait for the current to stabilize.

6. The output voltage-based self-adaptive rotor pre-positioning control method for a permanent magnet synchronous motor according to claim 5, wherein the coefficient of variation γ of the d-axis feedback current i_{d} is calculated using the following method:
a: selecting a feedback current is calculated through N consecutive times of sampling, wherein a feedback current i_{d} of a j^{th} time is denoted as id j;
b: calculating an average current of the feedback currents i_{d} of the N times:
$${i}_{d \_ ave} = \frac{{\sum }_{j = 1}^{N} {i}_{d \_ j}}{N} ;$$
c: calculating a standard deviation of the feedback currents i_{d} of the N times:
$$σ = \sqrt{\frac{{\sum }_{j = 1}^{N} {( {i}_{d \_ j} - {i}_{d \_ ave} )}^{2}}{N}} ;$$
and
d: calculating a coefficient of variation of the feedback currents i_{d} of the N times:
$$γ = \frac{σ}{{i}_{d \_ ave}} .$$

7. The output voltage-based self-adaptive rotor pre-positioning control method for a permanent magnet synchronous motor according to claim 6, wherein a value range of the set coefficient of variation value γₒ is 0.1 to 0.2.

8. The output voltage-based self-adaptive rotor pre-positioning control method for a permanent magnet synchronous motor according to claim 7, wherein a value range of the set current value iₒ is 40% to 60% of a rated current of the motor.
